(19) United States
(12) Patent Application Publication
(10) Pub. No.: US 2026/0330309 A1
(43) Pub. Date: Oct. 22, 2026

(54) COALITION LEARNING FOR TRAINING OF DISTRIBUTED MACHINE LEARNING WORKLOADS

(71) Applicant: Telefonaktiebolaget LM Ericsson (publ), Stockholm (SE)

(72) Inventors: Hasan FAROOQ, Santa Clara, CA (US); Julien FORGEAT, San Jose, CA (US); Kristijonas CYRAS, Santa Clara, CA (US); Shruti BOTHE, Santa Clara, CA (US)

(73) Assignee: Telefonaktiebolaget LM Ericsson (publ), Stockholm (SE)

(21) Appl. No.: 19/483,574

(22) PCT Filed: Jun. 5, 2023
(86) PCT No.: PCT/IB2023/055780

§ 371 Date: Nov. 11, 2025

(51) Int. Cl. G06N 20/00

(52) U.S. Cl. CPC G06N 20/00

(57) ABSTRACT

A method performed by a network entity in a mobile network is disclosed to determine a configuration for a machine learning workload. The method includes determining that the machine learning workload and one or more other machine learning workloads are members of a same coalition, training the machine learning workload using a first set of trial configurations, sharing a subset of the first set of trial configurations with one or more network entities that are responsible for configuring the one or more other machine learning workloads, obtaining a second set of trial configurations shared by the one or more network entities that are responsible for configuring the one or more other machine learning workloads, and warm starting a configuration optimization process for the machine learning workload using the second set of trial configurations.

### TECHNICAL FIELD

Embodiments of the invention relate to the field of distributed machine learning, and more specifically, to determining configurations for distributed machine learning workloads based on coalition learning.

### BACKGROUND

It is envisioned that beyond-5G networks (e.g., “5G-Advanced” and “6G” mobile networks) will be able to achieve ambitious quality of experience (QoE) requirements of unlimited capacity, zero latency and ultra-high reliability. As a result, it is expected that beyond-5G networks will be more complex, and thus will be more challenging to manage. Domain-specific advances in artificial intelligence (AI) and machine learning (ML) have the potential to enable the automation of future mobile networks for reducing operational expenses, enhancing QoE, and maximizing resource-usage efficiency. Advances in AI/ML are expected to pave the way for transforming the current semi-manual and trial-and-error based optimization and troubleshooting process used in mobile networks into an automated process that can achieve near-optimal results with no or minimal human involvement. For example, for Third Generation Partnership Project (3GPP) systems, a self-organizing network (SON) may leverage AI/ML to automatically plan, configure, manage, optimize, and/or heal mobile radio access networks (RANs). As another example, for open RAN (ORAN) architectures, r-Apps (or x-Apps) may leverage AI/ML to automatically evolve, deploy, optimize, and heal RANs.

ML workloads may leverage network data generated by the mobile network such as configuration management data, performance metrics, counters, traces, and/or key performance indicators (KPIs) to model spatiotemporal network behavior. A mobile network can leverage such network data to optimize downstream tasks such as positioning prediction, load forecasting, secondary carrier prediction, and/or radio propagation prediction to support various use cases such as mobility robustness optimization, load balancing, capacity and coverage optimization, outage detection, and/or network diagnostics with no or minimal human involvement.

Within a mobile network, the architecture placement of ML workloads is an important design consideration. ML workloads may run in a centralized data center or run in the edges of the mobile network (distributed locations such as centralized unit (CU) and distributed unit (DU) of RANs) depending on the use case and associated requirements such as latency requirements, computing resource requirements, memory resource requirements, data availability requirements, and/or privacy requirements. The edge ML paradigm is well-suited for distributed topologies such as mobile networks where most of the relevant data is generated at the edges. Instead of having to move data from the edges to a centralized data center or cloud for training and/or inference, computation can be performed at the edges, closer to the source of the data. Placing ML workloads at the edges of the mobile network allows for having a more complete insight into the operating environment, which enables more flexible and dynamic resource allocation and orchestration. Such mechanisms will be able to provide ultra-low bounded latency, scalability, ultra-high reliability, and signaling needs and requirements for beyond-5G applications. Moreover, some downstream tasks may require ML model development that is specifically tailored for the edge node. For example, cell load prediction and QoE prediction may benefit from having a separate personalized ML model for each RAN (as opposed to having a global generic model) to take into account the individual/intrinsic cell characteristics. In such cases, placing ML workloads at the edges of the mobile network (e.g., at or near the RANs) may be the most promising architecture.

The lifecycle of distributed edge ML workloads may employ several modules to implement tasks/phases such as data generation, data ingestion, data selection, feature engineering, batch engineering, algorithm selection, hyperparameter search, determining general training and inference parameters, and/or determining life cycle management (LCM) related parameters. Each module may be configured with configuration parameters having their own search space.

The performance of downstream tasks driving the network use cases is dependent on the performance of the ML workloads, which will only be able to achieve optimal performance when the configurations parameters of the modules involved are fully optimized.

An AutoML approach may be used to automatically optimize the configuration parameters of the modules of an individual ML workload throughout the lifecycle of the ML workload. However, the AutoML approach (e.g., using Auto-sklearn, Auto-pytorch, and/or Tpot) only focuses on optimizing individual ML workloads. For an ultra-dense mobile network deployment, running independent AutoML processes for numerous ML workloads distributed across numerous RANs (e.g., hundreds/thousands of RANs) is not scalable.

### SUMMARY

A method performed by a network entity in a mobile network is disclosed to determine a configuration for a machine learning workload. The method includes determining that the machine learning workload and one or more other machine learning workloads are members of a same coalition, training the machine learning workload using a first set of trial configurations, sharing a subset of the first set of trial configurations with one or more network entities that are responsible for configuring the one or more other machine learning workloads, obtaining a second set of trial configurations shared by the one or more network entities that are responsible for configuring the one or more other machine learning workloads, warm starting a configuration optimization process for the machine learning workload using the second set of trial configurations, determining that a subset of the one or more other machine learning workloads are close peers to the machine learning workload based on the machine learning workload performing similarly to the subset of the one or more other machine learning workloads when the machine learning workload is trained using the second set of trial configurations, performing the configuration optimization process to determine a third set of trial configurations, training the machine learning workload using the third set of trial configurations, sharing a subset of the third set of trial configurations with one or more network entities that are responsible for configuring the close peers, obtaining a fourth set of trial configurations from the one or more network entities that are responsible for configuring the close peers, training the machine learning workload using the fourth set of trial configurations, and continue performing the configuration optimization process until a trial budget is exhausted to search for an optimal configuration for the machine learning workload.

A non-transitory machine-readable storage medium is disclosed that provides instructions, which when executed by a network entity in a mobile network, causes the network entity to carry out operations for determining a configuration for a machine learning workload. The operations include determining that the machine learning workload and one or more other machine learning workloads are members of a same coalition, training the machine learning workload using a first set of trial configurations, sharing a subset of the first set of trial configurations with one or more network entities that are responsible for configuring the one or more other machine learning workloads, obtaining a second set of trial configurations shared by the one or more network entities that are responsible for configuring the one or more other machine learning workloads, warm starting a configuration optimization process for the machine learning workload using the second set of trial configurations, determining that a subset of the one or more other machine learning workloads are close peers to the machine learning workload based on the machine learning workload performing similarly to the subset of the one or more other machine learning workloads when the machine learning workload is trained using the second set of trial configurations, performing the configuration optimization process to determine a third set of trial configurations, training the machine learning workload using the third set of trial configurations, sharing a subset of the third set of trial configurations with one or more network entities that are responsible for configuring the close peers, obtaining a fourth set of trial configurations from the one or more network entities that are responsible for configuring the close peers, training the machine learning workload using the fourth set of trial configurations, and continue performing the configuration optimization process until a trial budget is exhausted to search for an optimal configuration for the machine learning workload.

A network device is disclosed herein that is to implement a network entity in a mobile network. The network device includes one or more processors and a non-transitory machine-readable storage medium that provides instructions, which when executed by the one or more processers, causes the network entity to carry out operations for determining a configuration for a machine learning workload. The operations include determining that the machine learning workload and one or more other machine learning workloads are members of a same coalition, training the machine learning workload using a first set of trial configurations, sharing a subset of the first set of trial configurations with one or more network entities that are responsible for configuring the one or more other machine learning workloads, obtaining a second set of trial configurations shared by the one or more network entities that are responsible for configuring the one or more other machine learning workloads, warm starting a configuration optimization process for the machine learning workload using the second set of trial configurations, determining that a subset of the one or more other machine learning workloads are close peers to the machine learning workload based on the machine learning workload performing similarly to the subset of the one or more other machine learning workloads when the machine learning workload is trained using the second set of trial configurations, performing the configuration optimization process to determine a third set of trial configurations, training the machine learning workload using the third set of trial configurations, sharing a subset of the third set of trial configurations with one or more network entities that are responsible for configuring the close peers, obtaining a fourth set of trial configurations from the one or more network entities that are responsible for configuring the close peers, training the machine learning workload using the fourth set of trial configurations, and continue performing the configuration optimization process until a trial budget is exhausted to search for an optimal configuration for the machine learning workload.

### BRIEF DESCRIPTION OF THE DRAWINGS

The invention may best be understood by referring to the following description and accompanying drawings that are used to illustrate particular embodiments of the invention. In the drawings:

FIG. 1 is a diagram showing the steps involved in a coalition learning method, according to some embodiments.

FIG. 2 is a diagram showing formation of coalitions, according to some embodiments.

FIG. 3 is a diagram showing a table of example trial configurations, according to some embodiments.

FIG. 4 is a diagram showing steps 2 to 5 of the coalition learning method in a mobile network deployment, according to some embodiments.

FIG. 5 is a diagram showing interactions between base stations for implementing a coalition learning method, according to some embodiments.

FIG. 6 is a flow diagram showing a method for determining a configuration for a machine learning workload using coalition learning, according to some embodiments.

FIG. 7 is a diagram showing one implementation example for particular embodiments of the solution described herein.

FIG. 8 is a diagram showing three specific examples of a network device that may be used to implement particular embodiments of the described solution.

### DETAILED DESCRIPTION

The following description describes methods and apparatus for determining a configuration for a machine learning (ML) workload based on coalition learning. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

The lifecycle of distributed edge ML workloads may employ several modules to implement tasks/phases such as data generation, data ingestion, data selection, feature engineering, batch engineering, algorithm selection, hyperparameter search, determining general training and inference parameters, and/or determining life cycle management (LCM) related parameters. The configuration parameters for each module may have their own search space.

For example, the configurations for various modules in the context of a secondary carrier prediction use case (e.g., predicting whether a UE can receive better network performance if it switches over to a different carrier) is provided in table I below.

TABLE I

| Module | Configuration |
|---|---|
| Data generation/ | Turn secondary carrier scanning on for |
| instrumentation | these particular UEs (50% edge UEs, 50% |
| | center UEs, etc.) |
| | Parameters: distribution of UEs selected |
| Data ingestion | Keep compressed/distilled version of |
| (retention) | previous two weeks data and raw form for |
| | last day data |
| Data selection | Use 70% for training, 20% for validation, |
| | and 10% for testing |
| Feature engineering | Use principal component analysis (PCA) |
| Batch engineering | Order the samples in increasing order of |
| | difficulty |
| Estimator selection | Use LightGBM (LightGBM, DNN, XGboost) |
| Hyper-Parameter | Use max depth equal to 10 (max_depth, |
| Search | learning_rate, number of estimators) |
| Training | Use graphics processing units (GPUs) in |
| | lightly loaded cells |
| Inference | Use edge accelerators in heavily loaded cells |
| Life-cycle | Retrain when root mean square error loss is |
| management | greater than 1.7 |

As mentioned above, an AutoML approach may be used to automatically optimize the configuration parameters of the modules of an individual ML workload throughout the lifecycle of the ML workload. However, the AutoML approach (e.g., using Auto-sklearn, Auto-pytorch, and/or Tpot) only focuses on optimizing individual ML workloads. For an ultra-dense mobile network deployment, running independent AutoML processes for numerous ML workloads distributed across numerous RANs is not scalable.

Some ML workloads may have similar input features and thus it may be helpful for those ML workloads to learn from each other. However, due to the independent mode of operation, the AutoML approach may end up finding sub-optimal configurations.

The present disclosure describes a resource-efficient distributed coalition learning method that reduces the resources required to train L ML workloads (e.g., traffic forecasting ML workload, secondary carrier prediction ML workload, channel estimation ML workload, etc.) that are distributed across M network entities (e.g., base stations and/or UEs), with each lifecycle management pipeline having N modules (e.g., a data generation module, a hyperparameter search module, an algorithm selection module, etc.), and each module having a search space of size Λ_{N}. The coalition learning method exploits the synergy between the ML workloads to allow network entities running the ML workloads to collaborate with each another during the learning phase and thereby improve the collective performances of the ML workloads in a resource-efficient manner. Embodiments cluster ML workloads that have similar dataset features into coalitions. The network entities running ML workloads that are members of the same coalition may share knowledge with each other to help improve the search for an optimal configuration in a resource-efficient manner. This way of learning based on knowledge shared within a coalition may generally be referred to herein as coalition learning.

An embodiment is a method performed by a network entity in a mobile network to determine a configuration for a machine learning workload. The method includes determining that the machine learning workload and one or more other machine learning workloads are members of a same coalition, training the machine learning workload using a first set of trial configurations, sharing a subset of the first set of trial configurations with one or more network entities that are responsible for configuring the one or more other machine learning workloads, obtaining a second set of trial configurations shared by the one or more network entities that are responsible for configuring the one or more other machine learning workloads, warm starting a configuration optimization process for the machine learning workload using the second set of trial configurations, determining that a subset of the one or more other machine learning workloads are close peers to the machine learning workload based on the machine learning workload performing similarly to the subset of the one or more other machine learning workloads when the machine learning workload is trained using the second set of trial configurations, performing the configuration optimization process to determine a third set of trial configurations, training the machine learning workload using the third set of trial configurations, sharing a subset of the third set of trial configurations with one or more network entities that are responsible for configuring the close peers, obtaining a fourth set of trial configurations from the one or more network entities that are responsible for configuring the close peers, training the machine learning workload using the fourth set of trial configurations, and continue performing the configuration optimization process until a trial budget is exhausted to search for an optimal configuration for the machine learning workload.

A technological advantage of embodiments disclosed herein is that they provide the ability for network entities running ML workloads to collaborate with each other to improve the performance of their respective ML workloads with less time complexity and without sharing private data. Also, a technical advantage of embodiments disclosed herein is that they allow for training ML workloads without having to transport training data from the edge to the centralized core or between ML workloads. Also, a technical advantage of embodiments disclosed herein is that they allow for training ML workloads to achieve better performance for a given trial budget or achieve the minimum required level of performance with fewer number of trials.

While certain advantages are mentioned above, those skilled in the relevant art will appreciate that embodiments may provide other advantages than those specifically mentioned above.

In a mobile network deployment scenario, a ML workload may run on a particular network entity of the mobile network such as a base station (BS) or user equipment (UE). For example, a position prediction ML workload may run on a first base station (base station #1) and a load forecasting ML workload may run on a second base station (base station #2). A convention is used herein where a ML workload running on a base station may be denoted as a concatenation of the base station number and an abbreviation of the ML workload type. For example, the position prediction ML workload running on the first base station may be referred to as “1PS” (“1” refers to the base station number and “PS” refers to position prediction), the load forecasting ML workload running on the second base station may be referred to as “2LF” (“2” refers to the base station number and “LF” refers to load forecasting), and so on. It should be noted that it is possible for multiple different ML workloads to run on the same network entity.

A formalism for describing embodiments will now be described. For each ML workload, let [symbol] ={n¹, n², . . . , n^{N}} be a set of N modules of the ML workload and let the configuration of each module n^{j} have a domain Λ^{j}. The data that a ML workload operates on may be split into a training dataset, Dₜᵣₐᵢₙ, and a validation dataset, D_{valid}. Let D_{train_ai}={(x₁, y₁), . . . , (xₜ, yₜ)}ₐᵢ denote the training data of the ML w_{orkload} ai (where x represents input features, y represents labels, and t represents the number of samples in a training dataset for a ML workload). Let

$${L ( {n}_{{λ}^{1}}^{1} , {n}_{{λ}^{2}}^{2} , … , {n}_{{λ}^{N}}^{N} , {D}_{train} , {D}_{valid} )}_{ai}$$

denote the validation loss (e.g., a root mean squared error) that the ML workload ai achieves on D_{valid} when trained on Dₜᵣₐᵢₙ with modules n¹ to n^{N} configured using configurations λ¹, λ², . . . , λ^{N}, respectively. Then, within a mobile network deployment scenario with z ML workloads, the optimization problem is to find the configurations for all modules of all z ML workloads involved that minimizes loss as described in the below formula:

$${[ {λ}_{a 1}^{1} , {λ}_{a 2}^{1} , … , {λ}_{az}^{1} , {λ}_{a 1}^{2} , {λ}_{a 2}^{2} … , {λ}_{az}^{N} ]}_{1 \times ( N \times Z )}^{*} arg min Ω ( {L}_{a 1} , {L}_{a 2} , … , {L}_{az} )$$

In the above formula, Ω denotes an objective function that can be, for example, an average mean for losses of all z ML workloads or downstream task's KPIs (e.g., energy efficiency, signal-to-noise ratio (SINR), cell loads, throughputs). In an embodiment, the objective function incudes a weighted sum of KPIs (or other performance metric), where different weights are assigned to different KPIs/metrics based on their importance/priority.

A conventional AutoML approach may be able to optimize the configuration of the modules, but only for each ML workload independently. Thus, the AutoML approach does not scale well as the number of ML workloads and modules increases, which makes it inefficient and unusable in many practical deployments. As will be further described herein, embodiments provide a coalition learning method that can determine optimal (or near optimal) configurations for distributed ML workloads in a resource-efficient manner. Embodiments will now be described in further detail with reference to the accompanying figures.

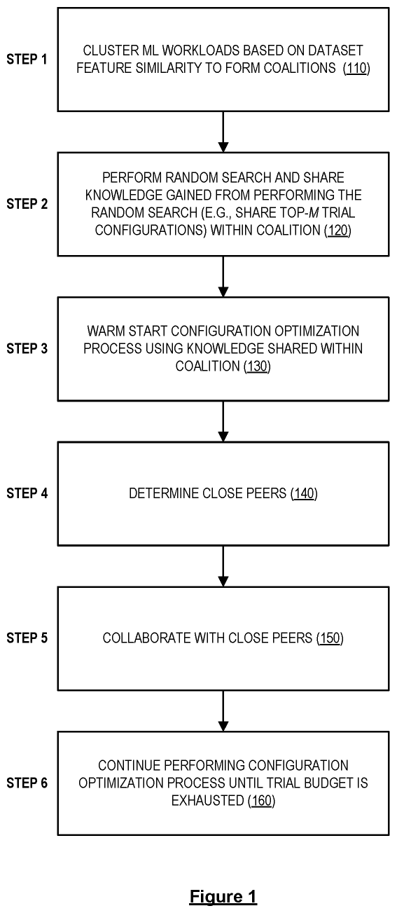

FIG. 1 is a diagram showing the steps involved in a coalition learning method, according to some embodiments.

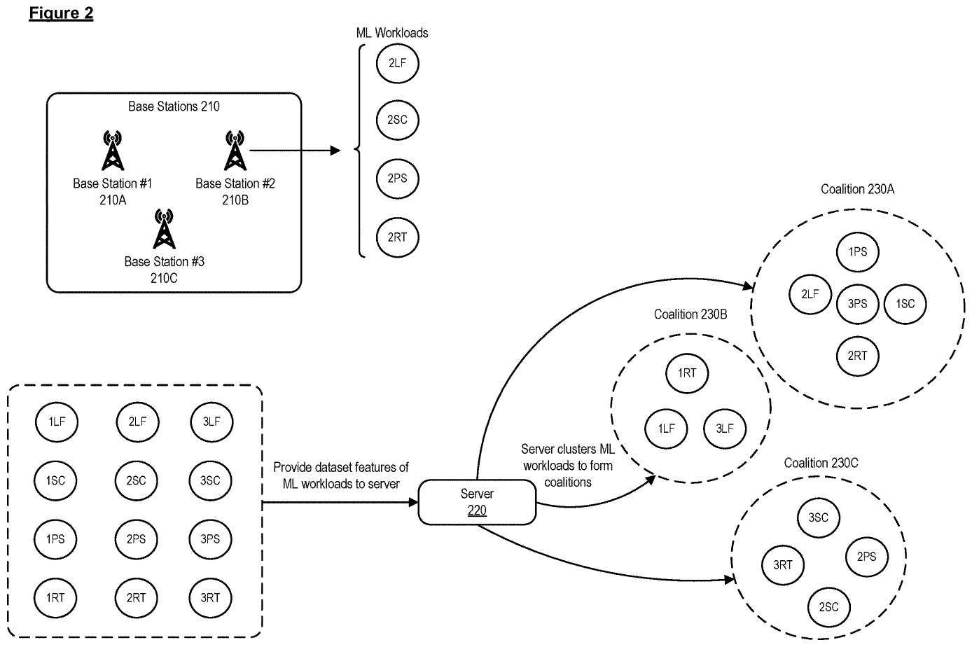

As shown in the diagram, in an embodiment, the coalition learning method may involve six steps. At step 1 (110), a server clusters ML workloads based on dataset feature similarity (e.g., similarity of the dataset that is used to train a ML workload) to form coalitions. ML workloads may be clustered based on dataset feature similarity because it has been observed that ML algorithms (e.g., estimators) tend to have similar performance for the same configuration for similar datasets. By way of example, the dataset features may include but are not limited to: 1) general features such as the number of attributes that are categorical or numeric and the overall number of data points; 2) statistical features that characterize higher-order properties of data distribution such as the correlation/covariance and metrics of dispersion (e.g. skewness or kurtosis); and/or 3) information-theoretic features based on entropy such as mutual information and noise-to-signal ratio. Other examples of dataset features are temporal features, spectral features, and radio domain features. The particular dataset features that are used to form coalitions may vary depending on the use case. In an embodiment, the topology of the mobile network and/or a connectivity graph can be used to set constraints when clustering ML workloads into coalitions. The choice of constraints for further refining a cluster membership can depend upon the compute capabilities of the network entities running the ML workloads, so that, for example, ML workloads running on resource-constrained network entities (e.g., base stations) or network entities experiencing high load are excluded from being placed in a coalition. An example of a coalition formation is shown in FIG. 2 and described in further detail below.

FIG. 2 is a diagram showing an example formation of coalitions, according to some embodiments.

As shown in the diagram, a mobile network may include base stations 210 such as base station 210A, base station 210B, and base station 210C. Each base station 210 may run one or more ML workloads. For example, as shown in the diagram, base station 210B may run a load forecasting ML workload (“2LF”), a secondary carrier prediction ML workload (“2SC”), a positioning prediction ML workload (“2PS”), and a ray tracing prediction ML workload (“2RT”) (e.g., which can be used for radio propagation modeling). The other base stations 210 (e.g., base station 210A and base station 210C) may run similar ML workloads. Each base station 210 is responsible for configuring and training its own ML workloads. Each base station 210 may extract the dataset features of its ML workloads and provide the extracted dataset features to a server 220 of the mobile network or other central network entity of the mobile network (e.g., via a network data analytics function (NWDAF) application programming interface (API)). For example, base station 210B may extract the dataset features of ML workloads 2LF, 2SC, 2PS, and 2RT and provide the extracted dataset features to the server 220. The other base stations 210 may also extract the dataset features of their respective ML workloads and provide the dataset features to the server 220. The server 220 may cluster the ML workloads based on dataset feature similarity to form coalitions 230. The server 220 may use any suitable clustering algorithm to cluster ML workloads (e.g., K-means clustering algorithm, density-based spatial clustering of applications with noise (DBSCAN) clustering algorithm, etc.). In the example shown in the diagram, the ML workloads are clustered into three coalitions: 1) coalition 230A, which includes ML workloads 1PS, 2LF, 3PS, 1SC, and 2RT; 2) coalition 230B, which includes ML workloads 1RT, 1LF, and 3LF; and 3) coalition 230C, which includes ML workloads 3SC, 3RT, 2PS, and 2SC. A base station may then receive an indication from the server that the ML workload and the one or more other ML workloads are members of the same coalition.

Returning to FIG. 1, at step 2 (120), the network entities running ML workloads perform a random search and share the knowledge gained from performing the random search with network entities running other ML workloads that are members of the same coalition. In an embodiment, a network entity running a ML workload may initially perform i independent trials on its ML workload using random search and share its knowledge (experiences) with other network entities running other coalition members. The knowledge that is shared may be some function of the i independent trials performed so far. As used herein, unless the context indicates otherwise, a trial refers to training a ML workload using a particular configuration (also referred to as a trial configuration). For example, a network entity running a ML workload may share the top-m trial configurations from the random search with the network entities running other ML workloads that are members of the same coalition. Using the formalism, assuming there are N modules involved in the training pipeline, a network entity running a ML workload may share the top-m trial configurations

$$( {λ}_{1}^{1} , {λ}_{1}^{2} , … , {λ}_{1}^{N} , {λ}_{2}^{1} , {λ}_{2}^{N} , … , {λ}_{m}^{1} , … , {λ}_{m}^{N} ) .$$

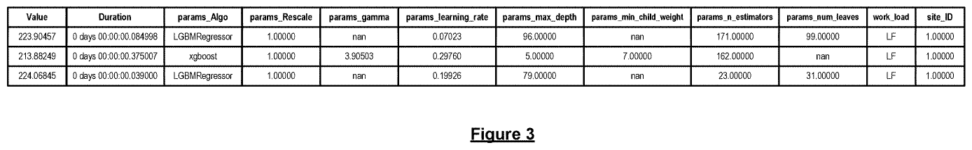

A trial configuration may be rated based on the validation loss that is achieved by a ML workload when the ML workload is trained using the trial configuration (e.g., so the top-m trial configurations may be the m trial configurations that achieved the lowest validation loss during the random search). In an embodiment, a network entity running a ML workload shares m trial configurations that include both the top and worst performing trial configurations (e.g., the top performing trial configurations can be tagged to indicate they are the top performers and the worst performing trial configurations can be tagged to indicate they are the worst performers). In an embodiment, the network entity running a ML workload also shares the validation loss value for each trial configuration that is being shared. In an embodiment, a network entity running a ML workload may share its knowledge (e.g., trial configurations) using a 3GPP network interface such as a Xn interface. Example trial configurations are shown in FIG. 3.

FIG. 3 is a diagram showing a table of example trial configurations, according to some embodiments.

Each row in the table represents a trial configuration. The “Value” column indicates a validation loss achieved with the trial configuration, the “Duration” column indicates time spent on training with the trial configuration, the “params_Algo” column indicates the ML algorithm (estimator) used in training, the “params_Rescale” column indicates the method used for rescaling (e.g., a value of “1.00000” refers to a min-max scaling method), the “params_gamma” column indicates the value of gamma hyperparameter for xgboost, the “params_learning_rate” column indicates the value of learning rate hyperparameter for the ML algorithms, the “params_max_depth” column indicates the value of max depth hyperparameter for xgboost and light gradient boosting machine (LGBM) ML algorithms, the “params_min_child_weight” column indicates the value of min child weight hyperparameter for xgboost, the “params_n_estimators” column indicates the value of num of estimators hyperparameter for ML algorithms, the “params_num_leaves” column indicates the value of num leaves hyperparameter for LGBM ML algorithm, the “work_load” column indicates an identifier for the ML workload, and the “site_ID” column indicates the identifier for the base station running the ML workload. For example, the first trial configuration (represented by the first row of the table) uses a LightGBM Regressor algorithm (as indicated in the “params_Algo” column) and uses 171 estimators (as indicated in the “params_n_estimators” column). The first trial configuration achieves a validation loss of 223.90457 (as indicated in the “Value” column). The other rows in the table can be interpreted in a similar manner.

Returning to FIG. 1, at step 3 (130), the network entities running ML workloads warm start a configuration optimization process using the knowledge shared within a coalition. Once all of the network entities running ML workloads belonging to the same coalition have shared their knowledge (e.g., top-m trial configurations) with each other, they may use the shared knowledge to warm start a configuration optimization process for their respective ML workloads. For example, a network entity running a ML workload may use the shared knowledge to warm start a configuration optimization process (e.g., a black-box optimization-based search) for its ML workload and perform j number of trials. As an example, in an embodiment where the configuration optimization process is a Bayesian search process, a network entity running a ML workload may seed start the Bayesian search process using the knowledge shared by the network entities running ML workloads that are members of the same coalition. In a conventional Bayesian search process, random trials are initially performed to learn a surrogate regression model (e.g., a probabilistic function mapping hyperparameters to a probability of a score on the objective function) based on a set of already observed data points. An acquisition function based on the surrogate model may then be used to identify promising new configurations. A conventional Bayesian search process generally finds the best hyperparameter configuration from a random initialization without any prior knowledge, given a sufficient number of trials. In contrast, by sharing knowledge (e.g., top-m trial configurations), embodiments allow the Bayesian search process to get a “head start” (e.g., learn the surrogate model) using the trial configurations that were deemed successful (and/or unsuccessful) on similar datasets. The number of trials performed by a network entity for a ML workload may thus be i+(m*(C−1))+j, where i is the number of independent trials that the network entity performs, C is the coalition size (the number of ML workloads in the coalition), m is the number of top-m best performing trial configurations, and j is the number of trials performed after the warm start of the configuration optimization process. The warm start may help minimize the overall number of trials that need to be performed compared to a conventional configuration optimization process that does not employ knowledge sharing. In an embodiment, the configuration optimization process is a Bayesian search process. In an embodiment, the configuration optimization process is a genetic algorithm process. In such an embodiment, the i independent trial configurations may be used as random population in beginning.

At step 4 (140), the network entities running the ML workloads determine close peers of their respective ML workloads. A coalition is formed based on dataset feature similarity. However, within a given coalition, some members may be more similar to each other in terms of their performance when using the same configurations. Such members may be referred to herein as close peers. The threshold of what is considered to be “close” may be configurable. In an embodiment, two ML workloads may be considered to be close peers if they perform similarly (e.g., achieve similar validation loss) when trained using the same configurations. A network entity running a ML workload may compare the performance of its ML workload when trained using certain trial configurations to the performance of coalition members when those coalition members are trained using certain trial configurations to determine which coalition members are close peers. For example, using the overall best and worst validation loss values in all trials performed so far (e.g., i+(m*(C−1))+j trials, which may be available in the trial history), a network entity may normalize the validation loss achieved by its ML workload when using the top-m trial configurations for the coalition members (e.g., as shared by the network entities running the coalition members). The network entity may determine that a particular coalition member is a close peer of the network entity's ML workload if the normalized validation loss achieved by the network entity's ML workload, when using the top-m trial configurations for the coalition member, is below a predefined threshold γ. The value of the predefined threshold y may be configurable. While a certain way of determining close peers of a ML workload is described above to illustrate an embodiment, those skilled in the relevant art will appreciate that other embodiments may determine the close peers of a ML workload in different ways (e.g., any mechanism by which network entities can agree upon whether two different ML workloads are close peers can be used). It should be noted that no extra trials need to be performed in this step.

At step 5 (150), the network entities running the ML workloads collaborate with network entities running close peers.

Once the close peers are identified, the network entities running the close peers may share trial configurations with each other and try those trial configurations. For example, a network entity running a ML workload may share the top-k trial configurations (from the j trials that were performed after warm start) with the network entities running close peers of the ML workload. In an embodiment, a network entity running a ML workload may share its knowledge (e.g., trial configurations) using a 3GPP network interface such as a Xn interface.

At step 6 (160), the network entities running ML models continue performing the configuration optimization process for their respective ML workloads until their respective trial budgets are exhausted. For example, a network entity running a ML workload may continue to explore the remainder of the search space using the configuration optimization process (e.g., a black-box optimization process such as a Bayesian search process or a genetic algorithm search process) for the ML workload until the trial budget allocated to the ML workload is exhausted. For example, if the trial budget is B trials, then a network entity may perform B−i−(m*(C−1))−j−(k*[# of close peers]) trials for the ML workload in this step.

An example simulation result is provided to further highlight the advantages provided by the embodiments described herein. The simulation involves three base stations with each base station running four ML workloads (e.g., a secondary carrier prediction ML workload, a load prediction ML workload, a position prediction ML workload, and a ray tracing prediction ML workload). The simulation uses a real public dataset provided by a telecom company to model the traffic at each time step so that the traffic distribution closely resembles actual traffic. The data is generated for 1,000 timesteps and uses 70 percent of data for training and 30 percent of data for validation.

The search space for the ML workloads per base station is provided in table II below:

TABLE II

| Module | Algorithm Type | Values |
|---|---|---|
| Preprocessing | Rescale | None, Min-Max, Standard, Log transformer |
| Estimator | xgboost | Gamma [0.0 to 5.0], max depth [3 to 100], min child |
| | | weight [1 to 10], n_estimators [10 to 200], learning |
| | | rate [0.001 to 0.5] |
| | NN | Activation [tan, relu], hidden layer size [10 to 100] |
| | svm | kernel [linear, poly, rbf], C [1.0 to 5.0] |
| | Light GBM | max_depth [1 to 10], num_leaves [10 to 50], num |
| | | estimators [10 to 200], learning rate [0.001 to 0.5] |
| | Random forest | max depth [1 to 10], n estimators [10 to 200] |
| | KNN | n neighbors [3 to 50] |

As shown in table II, the preprocessing module may be configured to use different values for the rescale algorithm (e.g., none, min-max, standard, or log transformer). Also, the estimator module may be configured to use different algorithms. Also, each algorithm may be configured to use different values.

The performance of the coalition learning method was benchmarked against a default strategy (xgboost with default training pipeline for all workloads), a vanilla Bayesian running independently for each ML workload, a random search running independently for each ML workload, a Gossip sharing method where a network entity shares the top-m trial configurations for each ML workload with a network entity running a randomly chosen coalition member, and a meta-learner-based Coordinated HypEr-paramETer seArcH (CHEETAH) method. The parameters of the coalition based learning were set as follows: i∈{5, 10} (i is the number of initial trials performed), m=2 (m is the number of top-m trial configurations shared with coalition members), j=10 (j is the number of subsequent trials performed after warm start), k=1 (k is the number of top-k trial configurations shared with close peers) and γ=0.1 (threshold to be close peers). The total trial budget set for each ML workload was B=50 trials. All experiments were repeated five times. The result of the simulation showed that the coalition learning method led to improved performance for all four ML workloads. For example, the coalition learning method (with i set to 10) achieved the lowest average mean root mean square error (RMSE) for the load forecasting ML workload. Also, the coalition learning method exhibited faster convergence for the position estimation ML workload compared to the other methods.

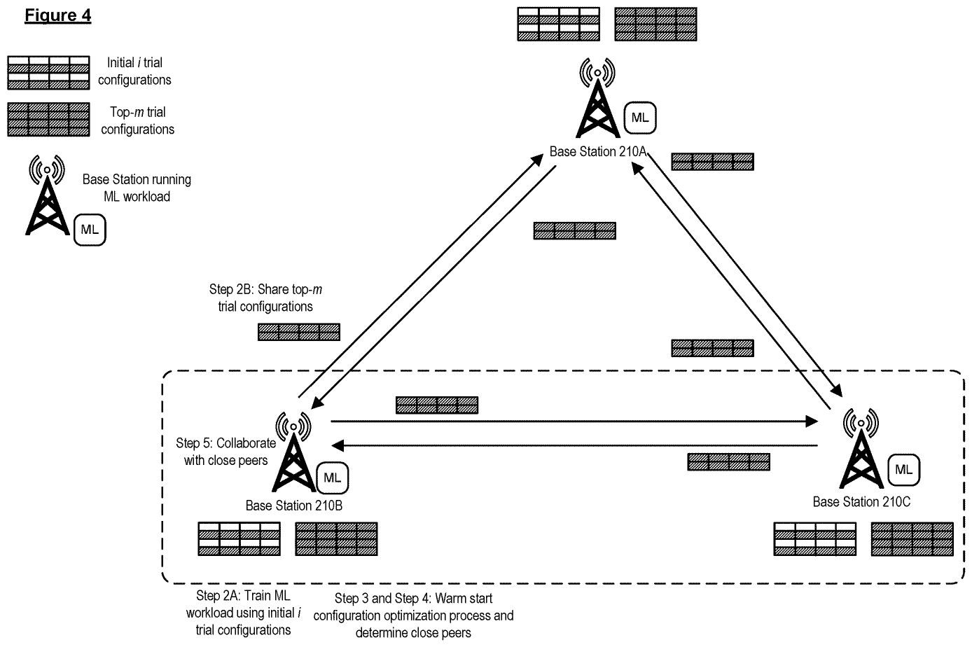

FIG. 4 is a diagram showing steps 2 to 5 of the coalition learning method in a mobile network deployment, according to some embodiments.

In the example shown in the diagram, the mobile network includes three base stations 210, each running a ML workload (denoted as “ML” in the diagram). The example shown in the diagram assumes that the ML workloads running on the three different base stations 210 are members of the same coalition (step 1 of the coalition learning method has been completed). In the diagram, the initial i trial configurations are depicted as a table with some shaded rows and some non-shaded rows. Each row represents a particular trial configuration. The shaded rows represent the top trial configurations.

At step 2A, the base station 210B trains its ML workload using an initial i trial configurations. At step 2B, the base station 210B shares the top-m trial configurations for its ML workload with the base stations running the other ML workloads that are members of the same coalition (base station 210A and base station 210C). Also, base station 210B receives the top-m trial configurations for the other ML workloads that are members of the same coalition from the base stations running these other ML workloads. At step 3, base station 210B warm starts the configuration optimization process using the trial configurations shared by the base stations running the other ML workloads. At step 4, base station 210B determines close peers of its ML workload. In this example, it is assumed that the ML workload running on base station 210B and the ML workload running on base station 210C are close peers, as depicted by the dotted line in the diagram (but not the ML workload running on base station 210A). At step 5, base station 210B collaborates with the base stations running the close peers (e.g., collaborates with base station 210C).

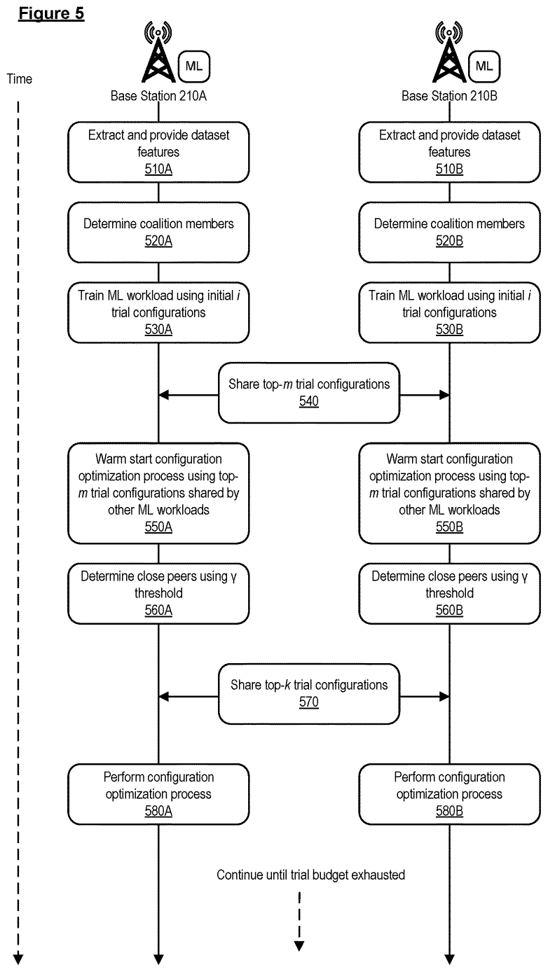

FIG. 5 is a diagram showing interactions between base stations for implementing a coalition learning method, according to some embodiments.

At operation 510A, base station 210A extracts and provides the dataset features of its ML workload to a central network entity. Similarly, at operation 510B, base station 210B extracts and provides the dataset features of its ML workload to the central entity.

At operation 520A, base station 210A determines coalition members of its ML workload. Similarly, at operation 520B, base station 210B determines coalition members of its ML workload. In this example, it is assumed that the ML workload running on base station 210A and the ML workload running on base station 210B are members of the same coalition (e.g., due to having similar dataset features). The base stations 210 may determine coalition members based on extracting and providing the dataset features of their respective ML workloads to a central server that clusters ML workloads based on dataset feature similarity to form coalitions and transmits indications of coalition members to the base stations, as described herein above.

At operation 530A, base station 210A trains its ML workload using an initial i trial configurations. Similarly, at operation 530B, base station 210B trains its ML workload using an initial i trial configurations.

At operation 540, base station 210A and base station 210B share the top-m trial configurations for their respective ML workloads (e.g., the trial configurations that achieved the lowest validation loss) with each other.

At operation 550A, base station 210A warm starts a configuration optimization process for its ML workload using the top-m trial configurations shared by base station 210B (and possibly other top performing trial configurations for members of the same coalition). Similarly, at operation 550B, base station 210B warm starts a configuration optimization process for its ML workload using the top-m trial configurations shared by base station 210A (and possibly other top performing trial configurations for members of the same coalition).

At operation 560A, base station 210A determines close peers of its ML workload (e.g., using the y threshold). Similarly, at operation 560B, base station 210B determines close peers of its ML workload (e.g., using the y threshold, as described above, or any other mechanism by which the base stations 210 can independently determine and agree that their ML workloads are close peers).

At operation 570, base station 210A and base station 210B perform the configuration optimization process for their respective ML workloads (e.g., for j trials) and share the top-k trial configurations with each other (and possibly with other base stations running close peers).

At operation 580A, base station 210A continues performing the configuration optimization process for its ML workload until its trial budget is exhausted to find an optimal configuration. Similarly, at operation 580B, base station 210B continues performing the configuration optimization process for its ML workload until its trial budget is exhausted to find an optimal configuration.

While embodiments are described herein primarily in the context of a mobile network environment, embodiments are not so limited. The coalition learning method disclosed herein may be used in other types of environments where ML workloads are distributed across network entities to learn configurations that will help optimize the ML workloads.

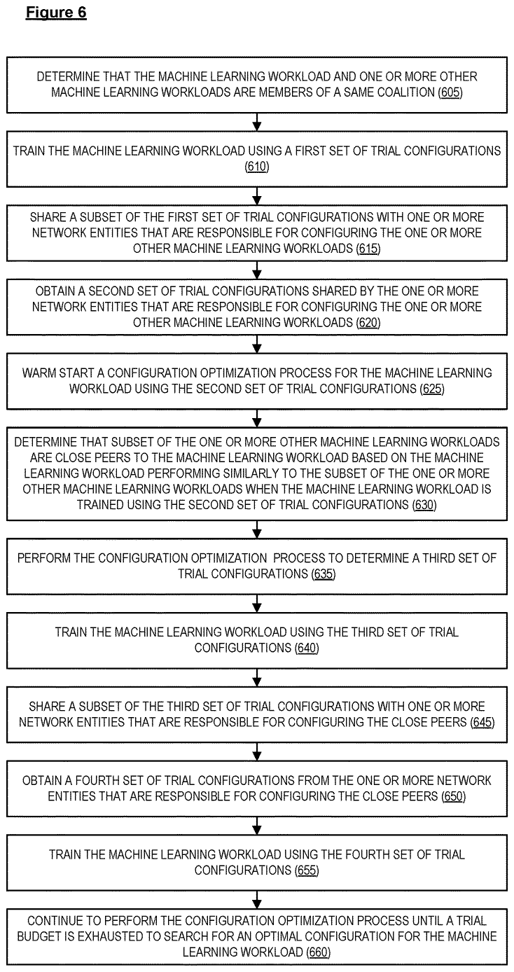

FIG. 6 is a flow diagram showing a method for determining a configuration for a machine learning workload using coalition learning, according to some embodiments. In an embodiment, the method is performed by a network entity running a ML workload. In an embodiment, the network entity is a base station or a UE of a mobile network.

The operations in the flow diagrams will be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

While the flow diagrams in the figures show a particular order of operations performed by certain embodiments, it should be understood that such order is provided by way of example and should not be regarded as limiting (e.g., alternative embodiments may perform the operations in a different order, combine certain operations, overlap certain operations, etc.).

At operation 605, the network entity determines that its machine learning workload and one or more other machine learning workloads are members of a same coalition.

In an embodiment, the network entity determines dataset features of the machine learning workload and sends the dataset features of the machine learning workload to a server, wherein the server is to cluster machine learning workloads having similar dataset features to form coalitions. The network entity may then receive an indication from the server that the machine learning workload and the one or more other machine learning workloads are members of the same coalition.

At operation 610, the network entity trains the machine learning workload using a first set of trial configurations (e.g., i initial trial configurations). In an embodiment, the first set of trial configurations is determined using a random search.

At operation 615, the network entity shares a subset of the first set of trial configurations with one or more network entities that are responsible for configuring the one or more other machine learning workloads. In an embodiment, the subset of the first set of trial configurations includes a predefined number of trial configurations from the first set of trial configurations that cause the machine learning workload to achieve the lowest validation loss (e.g., the top-m trial configurations). In an embodiment where the network entity is a base station, the subset of the first set of trial configurations may be shared with the one or more network entities that are responsible for configuring the one or more other machine learning workloads using a Xn interface of the mobile network.

At operation 620, the network entity obtains a second set of trial configurations shared by the one or more network entities responsible for configuring the one or more other machine learning workloads (e.g., top-m trial configurations for the coalition members).

At operation 625, the network entity warm starts a configuration optimization process for the machine learning workload using the second set of trial configurations. In an embodiment, the configuration optimization process is a Bayesian search process. In another embodiment, the configuration optimization process is a genetic algorithm process.

At operation 630, the network entity determines that a subset of the one or more other machine learning workloads are close peers to the machine learning workload based on the machine learning workload performing similarly to the subset of the one or more other machine learning workloads when the machine learning workload is trained using the second set of trial configurations. In an embodiment, the machine learning workload is determined to perform similarly to another machine learning workload if a normalized validation loss achieved by the machine learning workload when the machine learning workload is configured using trial configurations shared by a network entity responsible for configuring the another machine learning workload is below a threshold validation loss.

At operation 635, the network entity performs the configuration optimization process to determine a third set of trial configurations.

At operation 640, the network entity trains the machine learning workload using the third set of trial configurations (e.g., perform j trials after warm start).

At operation 645, the network entity shares a subset of the third set of trial configurations with one or more network entities responsible for configuring the close peers. In an embodiment, the subset of the third set of trial configurations includes a predefined number of trial configurations from the third set of trial configurations that cause the machine learning workload to achieve the lowest validation loss (e.g., the top-k trial configurations). In an embodiment where the network entity is a base station, the subset of the third set of trial configurations is shared with the close peers using a Xn interface of the mobile network.

At operation 650, the network entity obtains a fourth set of trial configurations from the one or more network entities responsible for configuring the close peers (e.g., top-k trial configurations for the close peers).

At operation 655, the network entity trains the machine learning workload using the fourth set of trial configurations.

At operation 660, the network entity continues to perform the configuration optimization process until a trial budget is exhausted to search for an optimal configuration for the machine learning workload.

In an embodiment, the coalition learning method can be performed without collaborating with close peers. For example, operations 630-655 may be optional in some embodiments.

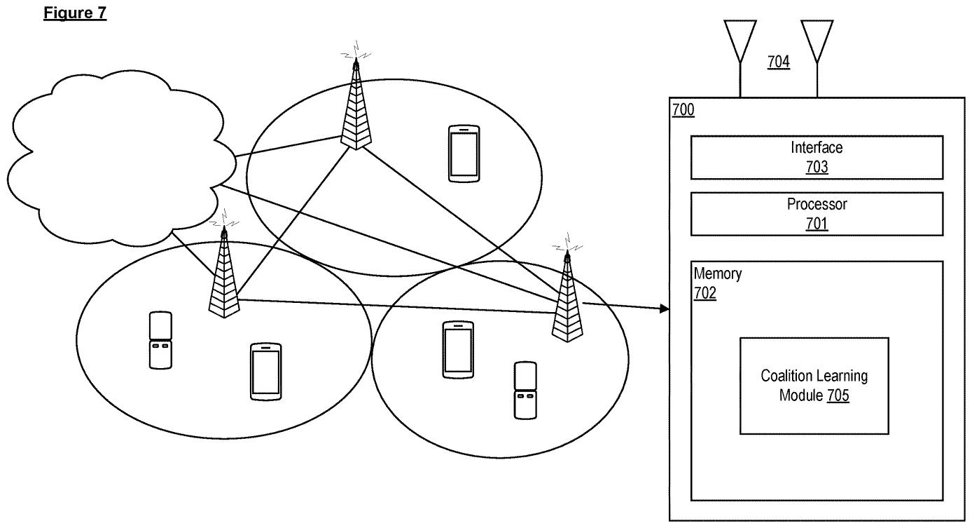

FIG. 7 is a diagram showing one implementation example for particular embodiments of the solution described herein.

Network device (ND) 700 may, in some embodiments, be an electronic device that can be communicatively connected to other electronic devices on the network (e.g., other network devices, user equipment devices (UEs), radio base stations, etc.). In certain embodiments, network device 700 may include radio access features that provide wireless radio network access to other electronic devices (for example a “radio access network device” may refer to such a network device) such as user equipment devices (UEs). For example, network device 700 may be a base station, such as eNodeB in Long Term Evolution (LTE), NodeB in Wideband Code Division Multiple Access (WCDMA) or other types of base stations, as well as a Radio Network Controller (RNC), a Base Station Controller (BSC), or other types of control nodes. As depicted in FIG. 7, the example network device 700 comprises processor 701, memory 702, interface 703, and antenna 704. These components may work together to provide various network device functionality as disclosed herein.

Processor 701 may be a microprocessor, controller, microcontroller, central processing unit, digital signal processor, application specific integrated circuit, field programmable gate array, any other type of electronic circuitry, or any combination of one or more of the preceding. The processor 701 may comprise one or more processor cores. In particular embodiments, some or all of the functionality described herein as being provided by network device 700 may be implemented by processor 701 executing software instructions, either alone or in conjunction with other network device 700 components, such as memory 702.

Memory 702 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals-such as carrier waves, infrared signals). For instance, memory 702 may comprise non-volatile memory containing code to be executed by processor 701. Where memory 702 is non-volatile, the code and/or data stored therein can persist even when the network device is turned off (when power is removed). In some instances, while network device 700 is turned on that part of the code that is to be executed by the processor(s) 701 may be copied from non-volatile memory into volatile memory (e.g., dynamic random access memory (DRAM), static random access memory (SRAM)) of network device 700.

Interface 703 may be used in the wired and/or wireless communication of signaling and/or data to or from network device 700. For example, interface 703 may perform any formatting, coding, or translating to allow network device 700 to send and receive data whether over a wired and/or a wireless connection. In some embodiments, interface 703 may comprise radio circuitry capable of receiving data from other devices in the network over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas 704 to the appropriate recipient(s). In some embodiments, interface 703 may comprise network interface controller(s) (NICs), also known as a network interface card, network adapter, local area network (LAN) adapter or physical network interface. The NIC(s) may facilitate in connecting the network device 700 to other devices allowing them to communicate via wire through plugging in a cable to a physical port connected to a NIC. As explained above, in particular embodiments, processor 701 may represent part of interface 703, and some or all of the functionality described as being provided by interface X103 may be provided more specifically by processor 701.

The components of network device 700 are each depicted as separate boxes located within a single larger box for reasons of simplicity in describing certain aspects and features of network device 700 disclosed herein. In practice however, one or more of the components illustrated in the example network device 700 may comprise multiple different physical elements (e.g., interface 703 may comprise terminals for coupling wires for a wired connection and a radio transceiver for a wireless connection).

The solution described herein may be implemented in the network device 700 by means of a computer program comprising instructions which, when executed on at least one processor, cause the at least one processor to carry out the actions according to any of the above features and embodiments, where appropriate. For example, memory 702 may include a coalition learning module 705 that when executed by processor 701 causes the ND 700 to perform a coalition learning method, as described herein above.

While the modules are illustrated as being implemented in software stored in memory 702, other embodiments implement part or all of each of these modules in hardware.

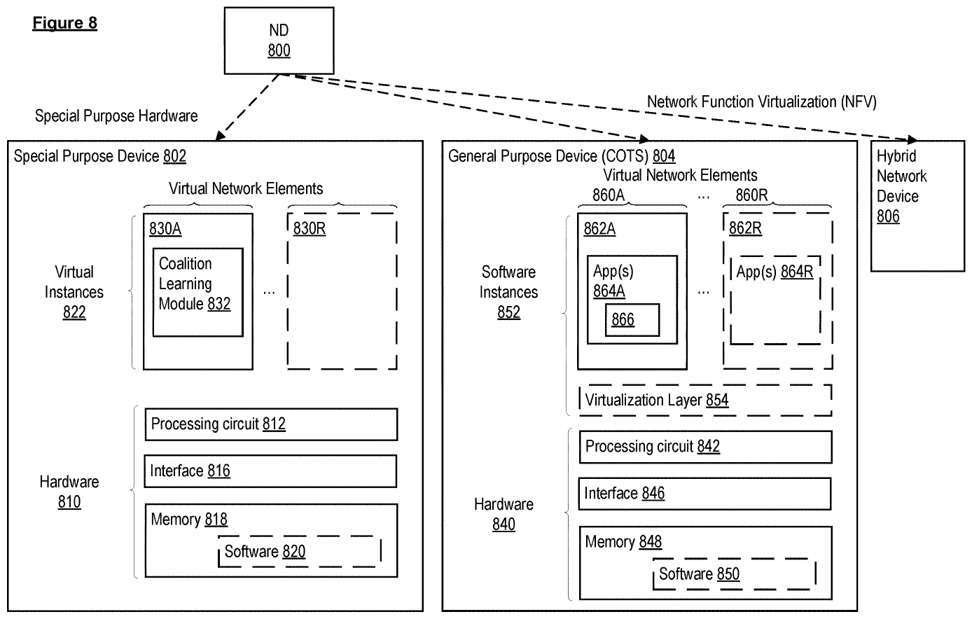

FIG. 8 is a diagram showing two specific examples of how a ND may be implemented in certain embodiments of the described solution including: 1) a special-purpose network device 802 that uses custom processing circuits such as application-specific integrated-circuits (ASICs) and a proprietary operating system (OS); and 2) a general purpose network device 804 that uses common off-the-shelf (COTS) processors and a standard OS which has been configured to provide one or more of the features or functions disclosed herein.

Special-purpose network device 802 includes hardware 810 comprising processor(s) 812, and interface 816, as well as memory 818 having stored therein software 820. During operation, the software 820 may be executed by the hardware 810 to instantiate a set of one or more virtual instance(s) 822. Each of the virtual instance(s) 822, and that part of the hardware 810 that executes that virtual instance (be it hardware dedicated to that virtual instance, hardware in which a portion of available physical resources (e.g., a processor core) is used, and/or time slices of hardware temporally shared by that virtual instance with others of the virtual instance(s) 822), form a separate virtual network element 830A-R. Thus, in the case where there are multiple virtual network elements 830A-R, each operates as one of the network devices from the preceding figures. In an embodiment, a virtual network element 830A implements a coalition learning module 832 to perform a coalition learning method, as described herein above.

Returning to FIG. 8, the example general purpose network device 804 includes hardware 840 comprising a set of one or more processor(s) 842 (which are often COTS processors) and interface 846, as well as memory 848 having stored therein software 850. During operation, the processor(s) 842 execute the software 850 to instantiate one or more sets of one or more applications 864A-R. In an embodiment, an application 864A implements a coalition learning module 866 to perform a coalition learning method, as described herein above. While certain embodiments do not implement virtualization, alternative embodiments may use different forms of virtualization. For example, in certain alternative embodiments virtualization layer 854 represents the kernel of an operating system (or a shim executing on a base operating system) that allows for the creation of multiple instances 862A-R called software containers that may each be used to execute one (or more) of the sets of applications 864A-R. In this embodiment, software containers 862A-R (also called virtualization engines, virtual private servers, or jails) are user spaces (typically a virtual memory space) that may be separate from each other and separate from the kernel space in which the operating system is run. In certain embodiments, the set of applications running in a given user space, unless explicitly allowed, may be prevented from accessing the memory of the other processes. In other such alternative embodiments virtualization layer 854 may represent a hypervisor (sometimes referred to as a virtual machine monitor (VMM)) or a hypervisor executing on top of a host operating system; and each of the sets of applications 864A-R may run on top of a guest operating system within an instance 862A-R called a virtual machine (which in some cases may be considered a tightly isolated form of software container that is run by the hypervisor). In certain embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 840, directly on a hypervisor (in which case the unikernel is sometimes described as running within a LibOS virtual machine), or in a software container, embodiments can be implemented fully with unikernels running directly on a hypervisor represented by virtualization layer 854, unikernels running within software containers represented by instances 862A-R, or as a combination of unikernels and the above-described techniques (e.g., unikernels and virtual machines both run directly on a hypervisor, unikernels and sets of applications that are run in different software containers).

The instantiation of the one or more sets of one or more applications 864A-R, as well as virtualization if implemented are collectively referred to as software instance(s) 852. Each set of applications 864A-R, corresponding virtualization construct (e.g., instance 862A-R) if implemented, and that part of the hardware 840 that executes them (be it hardware dedicated to that execution and/or time slices of hardware temporally shared by software containers 862A-R), forms a separate virtual network element(s) 860A-R.

The virtual network element(s) 860A-R perform similar functionality to the virtual network element(s) 830A-R. This virtualization of the hardware 840 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments of the invention may implement one or more of the software container(s) 862A-R differently. While embodiments of the invention are illustrated with each instance 862A-R corresponding to one VNE 860A-R, alternative embodiments may implement this correspondence at a finer level granularity; it should be understood that the techniques described herein with reference to a correspondence of instances 862A-R to VNEs also apply to embodiments where such a finer level of granularity and/or unikernels are used.

The third exemplary ND implementation in FIG. 8 is a hybrid network device 806, which includes both custom ASICs/proprietary OS and COTS processors/standard OS in a single ND or a single card within an ND. In certain embodiments of such a hybrid network device, a platform virtual machine (VM), such as a VM that that implements the functionality of the special-purpose network device 802, could provide for para-virtualization to the hardware present in the hybrid network device 806.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments are not described with reference to any particular programming language. It will be appreciated that a variety of programming languages may be used to implement the teachings of embodiments as described herein.

An embodiment may be an article of manufacture in which a non-transitory machine-readable storage medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Throughout the description, embodiments have been presented through flow diagrams. It will be appreciated that the order of transactions and transactions described in these flow diagrams are only intended for illustrative purposes and not intended to be limiting. One having ordinary skill in the art would recognize that variations can be made to the flow diagrams.

In the foregoing specification, embodiments have been described with reference to specific exemplary embodiments thereof. It will be evident that various modifications may be made thereto without departing from the broader spirit and scope of the disclosure provided herein. The specification and drawings are, accordingly, to be regarded in an illustrative sense rather than a restrictive sense.

1. A method performed by a network entity in a mobile network to determine a configuration for a machine learning workload, the method comprising:
determining that the machine learning workload and one or more other machine learning workloads are members of a same coalition;
training the machine learning workload using a first set of trial configurations;
sharing a subset of the first set of trial configurations with one or more network entities that are responsible for configuring the one or more other machine learning workloads;
obtaining a second set of trial configurations shared by the one or more network entities that are responsible for configuring the one or more other machine learning workloads;
warm starting a configuration optimization process for the machine learning workload using the second set of trial configurations;
determining that a subset of the one or more other machine learning workloads are close peers to the machine learning workload based on the machine learning workload performing similarly to the subset of the one or more other machine learning workloads when the machine learning workload is trained using the second set of trial configurations;
performing the configuration optimization process to determine a third set of trial configurations;
training the machine learning workload using the third set of trial configurations;
sharing a subset of the third set of trial configurations with one or more network entities that are responsible for configuring the close peers;
obtaining a fourth set of trial configurations from the one or more network entities that are responsible for configuring the close peers;
training the machine learning workload using the fourth set of trial configurations; and
continue performing the configuration optimization process until a trial budget is exhausted to search for an optimal configuration for the machine learning workload.

2. The method of claim 1, further comprising:
determining dataset features of the machine learning workload;
sending the dataset features of the machine learning workload to a server, wherein the server is to cluster machine learning workloads having similar dataset features to form coalitions; and
receiving an indication from the server that the machine learning workload and the one or more other machine learning workloads are members of the same coalition.

3. The method of claim 1, wherein the first set of trial configurations is determined using a random search.

4. The method of claim 1, wherein the subset of the first set of trial configurations includes a predefined number of trial configurations from the first set of trial configurations that cause the machine learning workload to achieve the lowest validation loss.

5. The method of claim 1, wherein the network entity is a base station, wherein the subset of the first set of trial configurations is shared with the one or more network entities that are responsible for configuring the one or more other machine learning workloads using a Xn interface of the mobile network.

6. The method of claim 1, wherein the configuration optimization process is a Bayesian search process.

7. The method of claim 6, wherein the warm starting includes seed starting a Bayesian search process using the second set of trial configurations.

8. The method of claim 1, wherein the configuration optimization process is a genetic algorithm process.

9. The method of claim 1, wherein the machine learning workload is determined to perform similarly to another machine learning workload if a normalized validation loss achieved by the machine learning workload when the machine learning workload is configured using trial configurations shared by a network entity responsible for configuring the another machine learning workload is below a threshold validation loss.

10. The method of claim 1, wherein the subset of the third set of trial configurations includes a predefined number of trial configurations from the third set of trial configurations that cause the machine learning workload to achieve the lowest validation loss.

11. The method of claim 1, wherein the network entity is a base station, wherein the subset of the third set of trial configurations is shared with the one or more network entities that are responsible for configuring the close peers using a Xn interface of the mobile network.

12. The method of claim 1, wherein the network entity is a user equipment (UE) of the mobile network.

13. A non-transitory machine-readable storage medium that provides instructions, which when executed by a network device implementing a network entity in a mobile network, causes the network entity to carry out operations for determining a configuration for a machine learning workload, the operations comprising:
determining that the machine learning workload and one or more other machine learning workloads are members of a same coalition;
training the machine learning workload using a first set of trial configurations;
sharing a subset of the first set of trial configurations with one or more network entities that are responsible for configuring the one or more other machine learning workloads;
obtaining a second set of trial configurations shared by the one or more network entities that are responsible for configuring the one or more other machine learning workloads;
warm starting a configuration optimization process for the machine learning workload using the second set of trial configurations;
determining that a subset of the one or more other machine learning workloads are close peers to the machine learning workload based on the machine learning workload performing similarly to the subset of the one or more other machine learning workloads when the machine learning workload is trained using the second set of trial configurations;
performing the configuration optimization process to determine a third set of trial configurations;
training the machine learning workload using the third set of trial configurations;
sharing a subset of the third set of trial configurations with one or more network entities that are responsible for configuring the close peers;
obtaining a fourth set of trial configurations from the one or more network entities that are responsible for configuring the close peers;
training the machine learning workload using the fourth set of trial configurations; and
continue performing the configuration optimization process until a trial budget is exhausted to search for an optimal configuration for the machine learning workload.

14. A network device to implement a network entity in a mobile network, the network device comprising:
one or more processors; and
a non-transitory machine-readable storage medium that provides instructions, which when executed by the one or more processors, causes the network entity to carry out operations for determining a configuration for a machine learning workload, the operations comprising:
determining that the machine learning workload and one or more other machine learning workloads are members of a same coalition,
training the machine learning workload using a first set of trial configurations,
sharing a subset of the first set of trial configurations with one or more network entities that are responsible for configuring the one or more other machine learning workloads,
obtaining a second set of trial configurations shared by the one or more network entities that are responsible for configuring the one or more other machine learning workloads,
warm starting a configuration optimization process for the machine learning workload using the second set of trial configurations,
determining that a subset of the one or more other machine learning workloads are close peers to the machine learning workload based on the machine learning workload performing similarly to the subset of the one or more other machine learning workloads when the machine learning workload is trained using the second set of trial configurations,
performing the configuration optimization process to determine a third set of trial configurations,
training the machine learning workload using the third set of trial configurations,
sharing a subset of the third set of trial configurations with one or more network entities that are responsible for configuring the close peers, obtaining a fourth set of trial configurations from the one or more network entities that are responsible for configuring the close peers,
training the machine learning workload using the fourth set of trial configurations, and
continue performing the configuration optimization process until a trial budget is exhausted to search for an optimal configuration for the machine learning workload.

15. The network device of claim 14, wherein the first set of trial configurations is determined using a random search.

16. The network device of claim 14, wherein the subset of the first set of trial configurations includes a predefined number of trial configurations from the first set of trial configurations that cause the machine learning workload to achieve the lowest validation loss.

17. The network device of claim 14, wherein the network entity is a base station, wherein the subset of the first set of trial configurations is shared with the one or more network entities that are responsible for configuring the one or more other machine learning workloads using a Xn interface of the mobile network.

18. The non-transitory machine-readable storage medium of claim 13, wherein the operations further comprise:
determining dataset features of the machine learning workload;
sending the dataset features of the machine learning workload to a server, wherein the server is to cluster machine learning workloads having similar dataset features to form coalitions; and
receiving an indication from the server that the machine learning workload and the one or more other machine learning workloads are members of the same coalition.

19. The non-transitory machine-readable storage medium of claim 13, wherein the first set of trial configurations is determined using a random search.

20. The non-transitory machine-readable storage medium of claim 13, wherein the subset of the first set of trial configurations includes a predefined number of trial configurations from the first set of trial configurations that cause the machine learning workload to achieve the lowest validation loss.
